(19) United States
(12) Patent Application Publication
(10) Pub. No.: US 2026/0136244 A1
(43) Pub. Date: May 14, 2026

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/706,294

(22) PCT Filed: Nov. 3, 2021
(86) PCT No.: PCT/CN2021/128496

§ 371 Date: Apr. 30, 2024

(51) Int. Cl. H04W 36/00; H04W 72/23

(52) U.S. Cl. CPC H04W 36/0061; H04W 36/0079; H04W 72/23

(57) ABSTRACT

Embodiments of the present disclosure relate to methods, devices and computer readable media for communication. A network device transmits, to a terminal device, a configuration to be applied to enable a data transmission on a cell of a second network device based on a lower-layer signaling, the first network device being a secondary node or a master node. The terminal device stores the configuration in a variable of the terminal device dedicated for the data transmission. In this way, a L1/L2 based procedure may be enabled.

### TECHNICAL FIELD

Embodiments of the present disclosure generally relate to the field of telecommunication, and in particular, to methods, devices and computer storage media of communication based on a lower-layer signaling.

### BACKGROUND

Currently, a change or addition or release of a serving cell is performed based on a radio resource control (RRC) signaling. However, a transmission and reception of the RRC signaling will cause a long latency, which results in a long delay and large signaling overhead in a scenario of a cell with a small coverage, e.g., a frequency 2(FR2 ) scenario and a central unit (CU)/distributed unit (DU) architecture, or for a terminal device moving in a high speed.

Some solutions to the above issue are proposed based on a lower-layer signaling such as layer 1 (L1 ) or layer 2 (L2) signaling, which may be collectively referred to as a L1/L2 based procedure. In one solution, a data transmission is performed without a change of a serving cell upon reception of the lower-layer signaling, which is also referred to as an inter-cell beam management. In another solution, a data transmission is performed with a change of a serving cell upon reception of the lower-layer signaling, which is also referred to as a L1/L2 based mobility. However, implementations of these solutions are still incomplete and to be further developed.

### SUMMARY

In general, embodiments of the present disclosure provide methods, devices and computer storage media of communication based on a lower-layer signaling.

In a first aspect, there is provided a method of communication. The method comprises: receiving, at a terminal device and from a first network device, a configuration to be applied to enable a data transmission on a cell of a second network device based on a lower-layer signaling, the first network device being a secondary node or a master node; and storing the configuration in a variable of the terminal device dedicated for the data transmission.

In a second aspect, there is provided a method of communication. The method comprises: transmitting, at a first network device and to a terminal device, a configuration to be applied to enable a data transmission on a cell of a second network device based on a lower-layer signaling, the first network device being a secondary node or a master node.

In a third aspect, there is provided a method of communication. The method comprises: transmitting, at a second network device and to a terminal device, a third message indicating that a cell of the second network device is to be released, a configuration to be applied to enable a data transmission on the cell based on a lower-layer signaling being stored in a variable of the terminal device dedicated for the data transmission.

In a fourth aspect, there is provided a terminal device. The terminal device comprises a processor configured to perform the method according to the first aspect of the present disclosure.

In a fifth aspect, there is provided a network device. The network device comprises a processor configured to perform the method according to the second aspect of the present disclosure.

In a sixth aspect, there is provided another network device. The network device comprises a processor configured to perform the method according to the third aspect of the present disclosure.

In a seventh aspect, there is provided a computer readable medium having instructions stored thereon. The instructions, when executed on at least one processor, cause the at least one processor to perform the method according to the first aspect of the present disclosure.

In an eighth aspect, there is provided a computer readable medium having instructions stored thereon. The instructions, when executed on at least one processor, cause the at least one processor to perform the method according to the second aspect of the present disclosure.

In a ninth aspect, there is provided a computer readable medium having instructions stored thereon. The instructions, when executed on at least one processor, cause the at least one processor to perform the method according to the third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a CU/DU architecture that may be established for a UP protocol stack at devices according to some embodiments of the present disclosure;

FIG. 2A illustrates a schematic diagram illustrating a process for storing a configuration to be applied to enable a L1/L2 based procedure according to embodiments of the present disclosure;

FIG. 2B illustrates a schematic diagram illustrating a process for enabling the L1/L2 based procedure based on the configuration according to embodiments of the present disclosure;

FIG. 2C illustrates a schematic diagram illustrating a process for performing a recovery from a failure based on the configuration according to embodiments of the present disclosure;

FIG. 2D illustrates a schematic diagram illustrating a process for reporting a failure in the data transmission according to embodiments of the present disclosure;

FIG. 3 illustrates an example method of communication implemented at a terminal device in accordance with some embodiments of the present disclosure;

FIG. 4 illustrates an example method of communication implemented at a network device in accordance with some embodiments of the present disclosure;

FIG. 5 illustrates another example method of communication implemented at a network device in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR 2(24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, the L1/L2 based procedure such as the inter-cell beam management or the L1/L2 based mobility is still incomplete in implementation. For example, it is unclear how to pre-configure and store a configuration for the L1/L2 based procedure. Further, it is indefinite on the contents of the L1/L2 signaling and UE behaviors upon reception of the L1/L2 signaling. Furthermore, it is unclear how to handle a failure in a master cell group (MCG) or secondary cell group (SCG) before triggering of the L1/L2 based procedure. In addition, it is unclear how to handle a failure in the L1/L2 based procedure.

Embodiments of the present disclosure provide a solution of communication for the L1/L2 based procedure so as to solve the above or other potential issues. In the solution, a terminal device receives a configuration for enabling the L1/L2 based procedure from a secondary node (SN) or a master node (MN) and stores the configuration in a variable of the terminal device dedicated for the L1/L2 based procedure. Upon reception of a L1/L2 signaling indicating that the L1/L2 based procedure is to be enabled, the terminal device may enable the L1/L2 based procedure based on the stored configuration. Upon detection of a radio link failure for a MCG or SCG, the terminal device may apply the stored configuration directly without reception of a L1/L2 signaling. Upon detection of a failure in the L1/L2 based procedure, the terminal device may report the failure to the MN or SN. In this way, the L1/L2 based procedure may be well implemented.

Principles and implementations of the present disclosure will be described in detail below with reference to the figures.

### Example of Communication Network

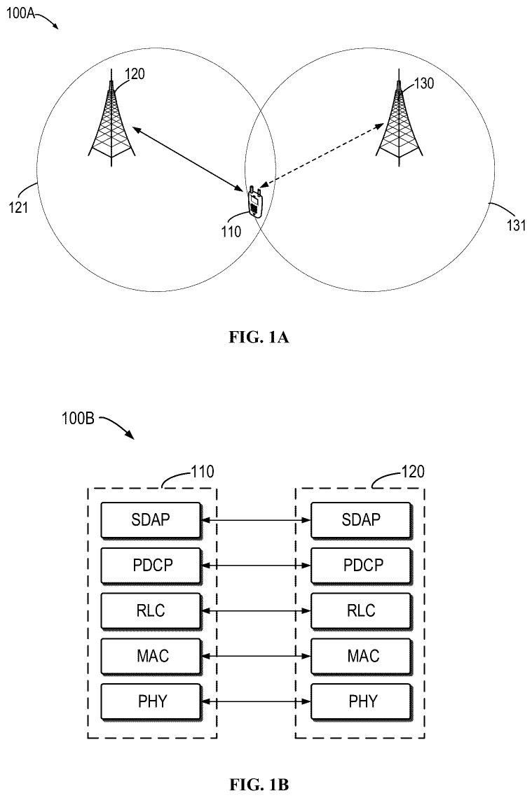

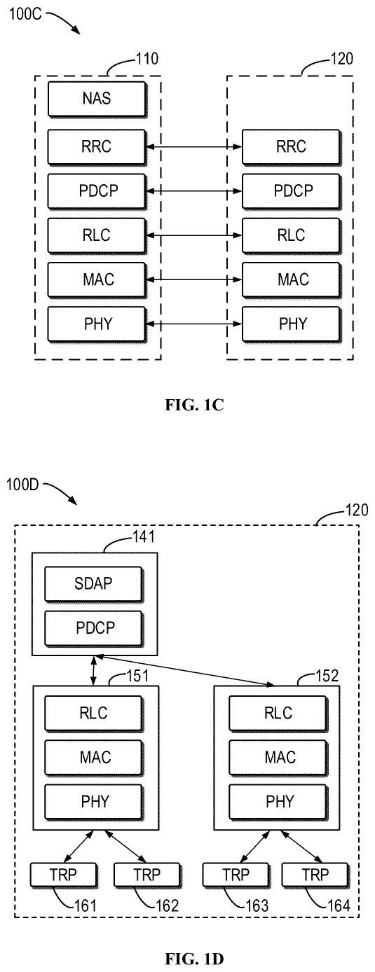

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a first network device 120 and a second network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G—Advanced networks, or the sixth generation (6G) networks.

Communication in a direction from the terminal device 110 towards the network device 120 or 130 is referred to as UL communication, while communication in a reverse direction from the network device 120 or 130 towards the terminal device 110 is referred to as DL communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture that may be established for a UP protocol stack at devices according to some embodiments of the present disclosure. The CU/DU architecture may be established at a network device. For illustration, the following description is given by taking the network device 120 as an example.

As shown in FIG. 1D, in the UP, the network device 120 may comprise one or more CUs. Here, only one CU 141 is shown for convenience. Each CU 141 may communicate with multiple DUs. Here, two DUs 151 and 152 are shown for illustration. It is to be understood that more DUs may also be provided for implementation of embodiments of the present disclosure. As shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may communicate with transmission and reception points (TRPs) 161 and 162. DU 152 may communicate with TRPs 163 and 164. It is to be understood that this is merely an example, and more or less TRPs are also feasible. The terminal device 110 may communicate with any of these TRPs so as to communicate with the network device 120.

In some embodiments, the terminal device 110 may switch from one TRP to another TRP under control of the same CU and same DU. For example, the terminal device 110 may be handed over from TRP 161 to TRP 162. This is called as an intra-DU serving cell change. In some embodiments, the terminal device 110 may switch from one TRP to another TRP under control of the same CU and different DUs. For example, the terminal device 110 may be handed over from TRP 162 to TRP 163. In this case, a cell change from DU 151 to DU 152 will occur. This is called as an inter-DU serving cell change. In another example, the terminal device 110 may be handed over from one TRP to another TRP under control of different CUs. In this case, a handover from a CU to another CU will occur. This is called as an inter-CU handover.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and the network device 130. For example, the network device 120 is a MN and the network device 130 is a SN. In some embodiments, the terminal device 110 may communicate with the network device 120 via a set of serving cells. The set of serving cells form a MCG, and a primary cell in the MCG is called as PCell. In some scenarios, the PCell may be changed from the cell 131 to another cell. This is called as a handover. In some embodiments, the terminal device 110 may communicate with the network device 130 via another set of serving cells. The other set of serving cells form a SCG, and a primary cell in the SCG is called as PSCell. It is to be understood that the number of cells in the MCG and SCG may be any positive integer. In some scenarios, the PSCell may be changed from the cell 131 to another cell. In some scenarios, the PSCell may be changed from the cell 131 to another cell. This is called as a PScell change.

In some scenarios, the terminal device 110 may be configured with an assistance cell or bandwidth part (BWP) or beam. For convenience, the following description is given by taking an assistance cell as an example. When the assistance cell is activated by a L1 or L2 signaling, the terminal device 110 may perform a data transmission via the assistance cell (also referred to as a non-serving cell) without a change of the serving cell. That is, the terminal device 110 may transmit or receive data via both the assistance cell and the serving cell. This procedure is called as the inter-cell beam management. In the context of the present disclosure, the term “data transmission” refers to the transmitting and receiving of data.

In some scenarios, the terminal device 110 may receive, from the network device 120, a L1 or L2 signaling indicating an addition or change or release of a serving cell. Upon the addition or change or release of the serving cell, the terminal device 110 may perform a data transmission with a modification or change of the serving cell. This procedure is called as the L1/L2 based mobility. As mentioned above, these procedures based on L1 or L2 signaling may be collectively referred to as a L1/L2 based procedure.

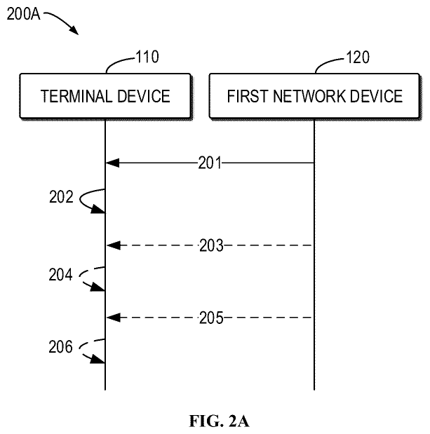

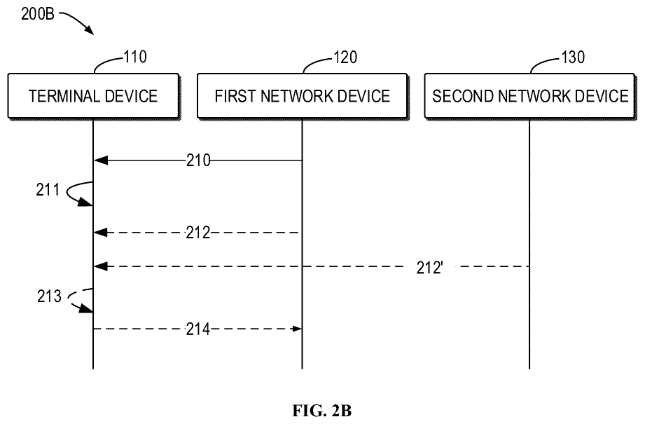

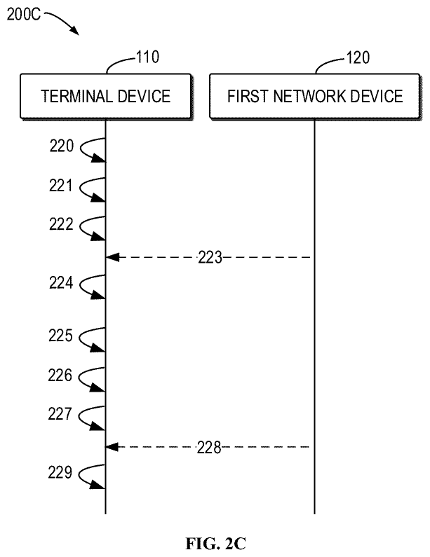

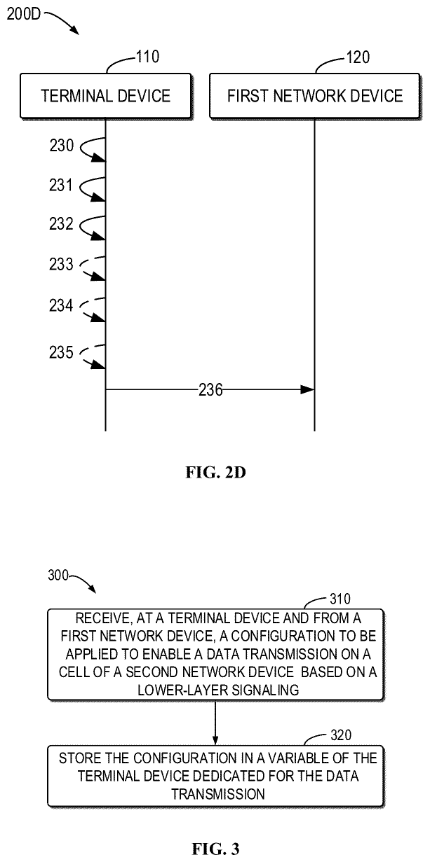

Embodiments of the present disclosure provide an improve solution of communication for the L1/L2 based procedure. Its details will be described with reference to FIGS. 2A to 2D.

### Example Implementation of Storing Configuration of L1/L2 Based Procedure

FIG. 2A illustrates a schematic diagram illustrating a process 200A for storing a configuration to be applied to enable a L1/L2 based procedure according to embodiments of the present disclosure. For the purpose of discussion, the process 200A will be described with reference to FIG. 1A. The process 200A may involve the terminal device 110 and the first network device 120 as illustrated in FIG. 1A. The first network device 120 may be a MN or SN serving the terminal device 110. In this example, the first network device 120 provides a serving cell for the terminal device 110. The second network device 130 does not provide a serving cell for the terminal device 110.

As shown in FIG. 2, the first network device 120 transmits 201, to the terminal device 110, a configuration to be applied to enable a data transmission on a cell of another network device (for example, the second network device 130) based on a lower-layer signaling. In other words, the first network device 120 may preconfigure a RRC configuration to be applied for a L1/L2 based procedure.

In some embodiments, the configuration may comprise a radio resource configuration. In some embodiments, the radio resource configuration may comprise at least one of the following: a radio bearer configuration, a MAC cell group configuration, or a physical channel configuration. For example, in some embodiments where an inter-CU scenario is supported, the radio bearer configuration may be configured. It is to be understood that these are merely examples and the radio resource configuration may also comprise any other suitable configurations or combinations of configurations.

In some embodiments, the configuration may comprise an AS security configuration. For example, the AS security configuration may be configured in some embodiments where an inter-CU scenario is supported. It is to be understood that the configuration to be applied for a L1/L2 based procedure may also comprise any other suitable configurations or combinations of configurations.

In some embodiments, the configuration may be associated with at least one of the following: an index of the configuration, information of the cell, or information of a beam. For example, the first network device 120 may preconfigure multiple RRC configurations for a L1/L2 based procedure for multiple cells or candidate cells. Each of the preconfigured RRC configurations may be associated with one index, information of the cell (e.g., identity (ID) such as Physical cell Identity (PCI), Cell ID, Cell Global Identity (CGI) or any other suitable information), or beam information (e.g., Synchronization Signal block (SSB) ID or any other suitable information). It is to be understood that different configurations for different cells may be identified by any other suitable information.

Upon reception of the configuration, the terminal device 110 stores 202 the configuration in a variable of the terminal device 110 dedicated for the L1/L2 based procedure. In some embodiments, if the configuration is to be applied for a data transmission (also referred to as a first data transmission herein) without a change of a serving cell, e.g., if the configuration is to applied for the inter-cell beam management, the terminal device 110 may store the configuration in a variable (also referred to as a first variable herein) of the terminal device 110. If the configuration is to be applied for a data transmission (also referred to as a second data transmission herein) with a change of a serving cell, e.g., the L1/L2 based mobility, the terminal device 110 may store the configuration in a variable (also referred to as a second variable herein) of the terminal device 110.

In some embodiments, the first variable and the second variable may be different variables. In this way, the terminal device 110 may store the configuration for the L1/L2 based mobility and the inter-cell beam management separately. Thus the terminal device 110 may easily handle the configuration and have different behaviors for the L1/L2 based mobility and the inter-cell beam management.

In some embodiments, the first variable and the second variable may be the same variable. In this way, the terminal device 110 may store the configuration for the L1/L2 based mobility and the inter-cell beam management in a simple and convenient way.

In some embodiments, if the terminal device 110 receives the configuration from the MN, the terminal device 110 may store the configuration in a variable (also referred to as a third variable herein) of the terminal device 110. In some embodiments, if the terminal device 110 receives the configuration from the SN, the terminal device 110 may store the configuration in a variable (also referred to as a fourth variable herein) of the terminal device 110.

In some embodiments, the third variable and the fourth variable may be different variables. In this way, the terminal device 110 may easily handle the configurations for MN and SN configured L1/L2 based procedures separately.

In some embodiments, the third variable and the fourth variable may be the same variable. In this way, the terminal device 110 may store the configurations for MN and SN configured L1/L2 based procedures in a simple and convenient way.

In some embodiments, the terminal device 110 may receive 203, from the first network device 120, a message (also referred to as a first message herein) indicating that the configuration is to be modified. For example, the first message may be a RRC message. Of course, the first message may also adopt any other suitable forms. In some embodiments, the first message may indicate an index, or cell information or beam information of a configuration to be modified. Based on the first message, the terminal device 110 may modify or update 204 the stored configuration in the variable correspondingly.

In some embodiments, the terminal device 110 may receive 205, from the first network device 120, a message (also referred to as a second message herein) indicating that the configuration is to be released. For example, the second message may be a RRC message. Of course, the second message may also adopt any other suitable forms. Based on the second message, the terminal device 110 may release or discard 206 the stored configuration from the variable correspondingly. In some embodiments, the second message may indicate an index, or cell information or beam information of a configuration to be released.

So far, the storage and update of the configuration for the L1/L2 based procedure is specified.

### Example Implementation of Enabling L1/L2 Based Procedure

FIG. 2B illustrates a schematic diagram illustrating a process 200B for enabling the L1/L2 based procedure based on the configuration according to embodiments of the present disclosure. For the purpose of discussion, the process 200B will be described with reference to FIG. 1A. The process 200B may involve the terminal device 110, the first network device 120 and the second network device 130 as illustrated in FIG. 1A. The first network device 120 may be a MN or SN serving the terminal device 110. In this example, the first network device 120 provides a serving cell for the terminal device 110. The second network device 130 does not provide a serving cell for the terminal device 110.

As shown in FIG. 2B, the first network device 120 may transmit 210, to the terminal device 110, a L1/L2 signaling indicating that the L1/L2 based procedure is to be enabled. In some embodiments, the L1/L2 signaling may be carried in a MAC control element (CE). In some embodiments, the L1/L2 signaling may be carried in downlink control information (DCI).

In some embodiments, the L1/L2 signaling may comprise information which may be mapped to the stored configuration. For example, the L1/L2 signaling may comprise an index of the configuration. As another example, the L1/L2 signaling may comprise information of a cell of the second network device 130. Alternatively or additionally, the L1/L2 signaling may comprise beam information. In another example, the L1/L2 signaling may comprise information indicating that a transmission configuration index (TCI) state is to be activated. It is to be understood that the L1/L2 signaling may comprise any combination of the above information and any other suitable information or combination of information.

Upon reception of the L1/L2 signaling, the terminal device 110 may enable 211 the corresponding L1/L2 based procedure. In some embodiments, a lower layer such as a MAC or PHY layer of the terminal device 110 may inform an RRC layer of the terminal device 110 that the L1/L2 signaling is received, and the RRC layer of the terminal device 110 may apply the configuration indicated by the L1/L2 signaling. For example, upon reception of the L1/L2 signaling, the TCI state for the cell of the second network device 130 may be activated. The lower layer may inform the RRC layer of the information comprised in the L1/L2 signaling, and the RRC layer may apply the stored configuration corresponding to the information.

In some embodiments, the terminal device 110 may release the stored configuration from the variable after the enabling of the L1/L2 based procedure. In some embodiments, the terminal device 110 may discard all entries of configuration stored in the variable. In some embodiments, the terminal device 110 may discard the entry for the corresponding configuration being triggered. In this way, the configurations which are configured for an old serving cell may be released and the storage resources of the configurations may be saved.

In some alternative embodiments, the terminal device 110 may maintain the stored configuration in the variable after the enabling of the L1/L2 based procedure. In this way, the stored configuration may be reused subsequently. In this case, a RRC message is unnecessary to be send to reconfigure the cell, and thus a fast L1/L2 based procedure may be enabled.

In some embodiments for the inter-cell beam management, the cell (i.e., assistance cell or non-serving cell) of the second network device 130 may be released. In some embodiments, the first network device 120 may transmit 212, to the terminal device 110, a message (also referred to as a third message herein) indicating that the cell of the second network device 130 is to be released. In some alternative embodiments, the second network device 130 may transmit 212′ the third message to the terminal device 110. In other words, both the serving cell of the first network device 120 and the cell of the second network device 130 may indicate the release of the cell of the second network device 130.

In some embodiments, the third message may be comprised in a MAC CE. In some embodiments, the third message may be comprised in DCI. In some embodiments, the third message may be RRC message. In some embodiments, the third message may comprise at least one of the following: an identity of the cell of the second network device 130, information of a beam, or information indicating that a TCI state of the cell of the second network device 130 is to be deactivated. Of course, any other suitable information may also be feasible.

Upon reception of the third message, the terminal device 110 may release 213 the cell of the second network device 130. For example, the lower layer of the terminal device 110 may indicate the third message to the RRC layer of the terminal device 110, and the RRC layer of the terminal device 110 may release the corresponding configuration.

In some embodiments where the second network device 130 indicates the release of the cell of the second network device 130, the terminal device 110 may transmit 214, to the first network device 110, a message (also referred to as a fourth message herein) indicating that the cell of the second network device 130 is released. That is, the terminal device 110 may inform the serving cell that the cell of the second network device 130 has been released. In some embodiments, the fourth message may be comprised in a MAC CE. In some embodiments, the fourth message may be comprised in DCI. In some embodiments, the fourth message may be comprised in a RRC signaling.

So far, cross layer interworking for the L1/L2 based procedure is described. With the above process 200B, the L1/L2 signaling may be used to trigger and terminate the L1/L2 based procedure.

### Example Implementation of Recovery Based on Stored Configuration

In some scenarios, a terminal device already preconfigured with a configuration for a L1/L2 based procedure may experience a communication failure in a MCG or SCG, for example, a radio link failure (RLF), a handover failure, or a PSCell change failure. In this case, as a radio resource has been reserved at the network side when the configuration for the L1/L2 based procedure is preconfigured by the network side, it is better to perform a recovery procedure by using the already preconfigured configuration without need of a L1/L2 signaling from the network side. Some example embodiments will be described with reference to FIG. 2C below.

FIG. 2C illustrates a schematic diagram illustrating a process 200C for performing a recovery from a failure based on the configuration according to embodiments of the present disclosure. For the purpose of discussion, the process 200C will be described with reference to FIG. 1A. The process 200C may involve the terminal device 110 and the first network device 120 as illustrated in FIG. 1A. The first network device 120 may be a MN or SN serving the terminal device 110. In this example, the first network device 120 provides a serving cell for the terminal device 110. The second network device 130 does not provide a serving cell for the terminal device 110. The terminal device 110 stores a configuration to be applied to enable a data transmission on a cell of the second network device 130 (i.e., a configuration for a L1/L2 based procedure).

As shown in FIG. 2C, the terminal device 110 may determine 220 that a failure for a MCG is detected. For example, the terminal device 110 may detect a RLF failure for the MCG. As another example, the terminal device 110 may detect a handover failure for the MCG.

Upon the determination of the failure for the MCG, the terminal device 110 may determine 221 a selected cell by performing a cell selection. Then the terminal device 110 may determine 222 whether the selected cell is the cell for which a configuration for a L1/L2 based procedure is pre-configured. In other words, the terminal device 110 may determine whether a configuration for a L1/L2 based procedure is pre-configured for the selected cell.

If determining that the selected cell is the cell of the second network device 130, i.e., the selected cell is pre-configured with a configuration for a L1/L2 based procedure, the terminal device 110 may initiate 224 a handover procedure by applying the stored configuration for the selected cell. In this way, the stored configuration for L1/L2 based handover for the selected cell is directly applied without a L1/L2 signaling from the first network device 120.

In some embodiments, the terminal device 110 may receive 223, from the first network device 120, information indicating whether the configuration is used for a recovery from the failure for the MCG. In other words, the first network device 120 may configure the terminal device 110 on whether a failure recovery using stored configuration for L1/L2 based mobility procedure is supported. If the information indicates that the failure recovery is supported, the terminal device 110 may initiate 224 the handover procedure using the stored configuration for L1/L2 based procedure after the failure for the MCG occurs.

Continue to with reference to FIG. 2C, the terminal device 110 may determine 225 that a failure for a SCG is detected. For example, the terminal device 110 may detect a RLF failure for the SCG. As another example, the terminal device 110 may detect a PSCell change failure for the SCG.

Upon the determination of the failure for the SCG, the terminal device 110 may determine 226 a selected cell fulfilling a predetermined criterion. For example, the selected cell should fulfill an IDLE/INACTIVE state cell selection criterion. It is to be understood that the predetermined criterion may be any suitable criteria for PSCell change, and the present disclosure does not limit this aspect. Then the terminal device 110 may determine 227 whether the selected cell is the cell for which a configuration for a L1/L2 based procedure is pre-configured. In other words, the terminal device 110 may determine whether a configuration for a L1/L2 based procedure is pre-configured for the selected cell.

If determining that the selected cell is the cell of the second network device 130, i.e., the selected cell is pre-configured with a configuration for a L1/L2 based procedure, the terminal device 110 may perform 229 a PSCell change procedure for the SCG by applying the stored configuration for the selected cell. In this way, the stored configuration for L1/L2 based PSCell change for the selected cell is directly applied without a L1/L2 signaling from the first network device 120.

In some embodiments, the terminal device 110 may receive 228, from the first network device 120, information indicating whether the configuration is used for a recovery from the failure for the SCG. In other words, the first network device 120 may configure the terminal device 110 on whether failure recovery using stored configuration for L1/L2 based mobility procedure is supported. If the information indicates that the failure recovery is supported, the terminal device 110 may perform 229 the PSCell change procedure using the stored configuration after the failure for the SCG occurs.

With the above recovery, the network connection may be recovered with less latency.

### Example Implementation of Reporting Failure in L1/L2 Based Procedure

In some scenarios, a terminal device may experience a failure in a L1/L2 based procedure. According to embodiments of the present disclosure, the terminal device may report this failure to the network side to help the network side to identity the reason of the failure. Some example embodiments will be described with reference to FIG. 2D below.

FIG. 2D illustrates a schematic diagram illustrating a process 200D for reporting a failure in the data transmission according to embodiments of the present disclosure. For the purpose of discussion, the process 200D will be described with reference to FIG. 1A. The process 200D may involve the terminal device 110 and the first network device 120 as illustrated in FIG. 1A. The first network device 120 may be a MN or SN serving the terminal device 110. In this example, the first network device 120 provides a serving cell for the terminal device 110. The second network device 130 does not provide a serving cell for the terminal device 110. Assuming that the terminal device 110 enables a L1/L2 based procedure by applying a configuration to be applied to enable a data transmission on a cell of the second network device 130.

As shown in FIG. 2D, the terminal device 110 may start 230 a timer upon the applying of the configuration. In some embodiments, the timer may be the timer T304. Of course, any other suitable timers existing or to be developed in future are also feasible. In some embodiments, the timer may have a shorter value. In some embodiments, a value of the timer may be indicated in the configuration for the L1/L2 based procedure.

In some embodiments, the terminal device 110 may determine 231 whether the timer expiries. In some embodiments, if the timer expires, the terminal device 110 may determine 232 that a failure in the L1/L2 based procedure occurs.

In some embodiments, if the data transmission on the cell of the second network device 130 is successfully enabled (i.e., the L1/L2 based procedure is successfully enabled) during running of the timer, the terminal device 110 may stop 233 the timer. For example, if the terminal device 110 completes a random access procedure towards the cell during the running of the timer, the terminal device 110 may stop the timer. In another example, if the terminal device 110 successfully receives a PDCCH transmission addressed to C-RNTI of the cell of the second network device 130, the terminal device 110 may stop the timer.

In some embodiments for an inter-cell beam management, the configuration for the L1/L2 based procedure may comprise a set of parameters for beam failure detection or RLF detection on the cell of the second network device 130. In these embodiments, the terminal device 110 may detect 234, based on the set of parameters, whether a beam failure or a RLF on the cell of the second network device 130 occurs. If the terminal device 110 detects the beam failure or RLF on the cell of the second network device 130, the terminal device 110 may determine 235 that a failure in the L1/L2 based procedure occurs.

Upon the determination 232 or 235 of the failure in the L1/L2 based procedure, the terminal device 110 may transmit 236 information of the failure to the first network device 120. In some embodiments, the terminal device 110 may transmit the information of the failure by a RRC message, for example, UEAssistanceInformation or any other suitable messages. In some embodiments, the terminal device 110 may transmit the information of the failure by a L1/L2 signaling, for example, a MAC CE or DCI or any other suitable signaling.

In some embodiments, the information of the failure may comprise an indication that the failure in the data transmission occurs. In some embodiments, the information of the failure may comprise an index of the configuration. In some embodiments, the information of the failure may comprise information of a cell associated with the failure, i.e., information of a failed cell. In some embodiments, the information of the failure may comprise information of a beam associated with the failure, i.e., information of a failed beam. It is to be understood that the information of the failure may comprise any combination of the above listed information and any other suitable information or combination of information.

In some embodiments, the terminal device 110 may transmit, to the MN, the information of the failure in a RLF report. For example, the terminal device 110 may store the information of the failure of the L1/L2 based procedure in the RLF report and report the RLF report to the MN. For example, in case of timer expiry of L1/L2 signaling based handover, the terminal device 110 may transmit, to the MN, the information of the failure of L1/L2 based procedure in the RLF report.

In some embodiments, the terminal device 110 may transmit, to the MN, the information of the failure in a RRC message. For example, the RRC message may be SCGFailureInformation, FailureInformation or UEAssistanceInformation message. It is to be noted that any other suitable messages existing or to be developed in future are also feasible. For example, in case of timer expiry of L1/L2 based mobility for SCG, the terminal device 110 may transmit, to the MN, the information of the failure of L1/L2 based procedure in the RRC message.

In some embodiments, the RRC message may comprise a SN RRC message (also referred to as a further RRC message herein), the information of the failure being comprised in the SN RRC message. For example, the RRC message may be a ULInformation TransferMRDC message, and the SN RRC message may be a FailureInformation message. It is to be noted that any other suitable messages existing or to be developed in future are also feasible. For example, in case of a beam failure or RLF on the cell for SCG without a SRB3 configured, the terminal device 110 may transmit, to the MN, the information of the failure of L1/L2 based procedure in the SN RRC message.

In some embodiments where a SRB3 is configured, the terminal device 110 may transmit, to the SN via the SRB3, a RRC message comprising the information of the failure. For example, the RRC message may be FailureInformation or UEAssistanceInformation message. It is to be noted that any other suitable messages existing or to be developed in future are also feasible. For example, in case of a beam failure or RLF on the cell for SCG with a SRB3 configured, the terminal device 110 may transmit, to the SN, the information of the failure of L1/L2 based procedure via the SRB3.

In some embodiments, if a L1/L2 signaling for enabling the L1/L2 based procedure is received from the MN, the terminal device 110 may transmit a L1/L2 signaling comprising the information of the failure to the MN correspondingly. For example, the terminal device 110 may transmit, to the MN, a MAC CE or DCI comprising the information of the failure. In some embodiments, if a L1/L2 signaling for enabling the L1/L2 based procedure is received from the SN, the terminal device 110 may transmit a L1/L2 signaling comprising the information of the failure to the SN correspondingly. For example, the terminal device 110 may transmit, to the SN, a MAC CE or DCI comprising the information of the failure. These embodiments may be applied for timer expiry of L1/L2 based mobility, or beam failure or RLF for MN or SN.

So far, a reporting of a failure in a L1/L2 based procedure is described. In this way, the serving cell is aware of the failure and may further optimize the network implementation.

### Example Implementation of Methods

Accordingly, embodiments of the present disclosure provide methods of communication implemented at a terminal device and a network device. These methods will be described below with reference to FIGS. 3 to 5.

FIG. 3 illustrates an example method 300 of communication implemented at a terminal device in accordance with some embodiments of the present disclosure. For example, the method 300 may be performed at the terminal device 110 as shown in FIG. 1A. For the purpose of discussion, in the following, the method 300 will be described with reference to FIG. 1A. It is to be understood that the method 300 may include additional blocks not shown and/or may omit some blocks as shown, and the scope of the present disclosure is not limited in this regard. Assuming that the first network device 120 may be a MN or SN serving the terminal device 110. The first network device 120 provides a serving cell (for example, the cell 121) for the terminal device 110. The second network device 130 does not provide a serving cell for the terminal device 110.

At block 310, the terminal device 110 receives, from the first network device 120, a configuration to be applied to enable a data transmission on the cell 131 of the second network device 130 based on a lower-layer signaling.

In some embodiments, the data transmission may be a data transmission (also referred to as a first data transmission herein) on the cell 131 without a change of a serving cell, for example, an inter-cell beam management. In some embodiments, the data transmission may be a data transmission (also referred to as a second data transmission herein) on the cell 131 with a change of a serving cell, for example, a L1/L2 based mobility.

In some embodiments, the configuration may be associated with at least one of the following: an index of the configuration, information of the cell 131 of the second network device 130, or information of a beam. For example, multiple configurations for different cells may be preconfigured, and the multiple configurations may be associated with different indexes of the configurations, information of cells, or information of beams.

In some embodiments, the configuration may comprise at least one of the following: a radio resource configuration, or an access stratum security configuration. In some embodiments, the radio resource configuration may comprise at least one of the following: a radio bearer configuration, a medium access control cell group configuration, or a physical channel configuration.

At block 320, the terminal device 110 stores the configuration in a variable of the terminal device 110 dedicated for the data transmission. In some embodiments, if the configuration is to be applied to enable the first data transmission, the terminal device 110 may store the configuration in a first variable of the terminal device 110. If the configuration is to be applied to enable the second data transmission, the terminal device 110 may store the configuration in a second variable of the terminal device 110. In some embodiments, the first variable and the second variable may be the same variable. In some embodiments, the first variable and the second variable may be different variables.

In some embodiments, if the configuration is received from the MN, the terminal device 110 may store the configuration in a third variable of the terminal device 110. If the configuration is received from the SN, the terminal device 110 may store the configuration in a fourth variable of the terminal device 110. In some embodiments, the third variable and the fourth variable may be the same variable. In some embodiments, the third variable and the fourth variable may be different variables.

In some embodiments, the terminal device 110 may receive, from the first network device 120, a first message indicating that the configuration is to be modified, and modify the stored configuration based on the first message. In some embodiments, the terminal device 110 may receive, from the first network device 120, a second message indicating that the configuration is to be released, and release the stored configuration based on the second message.

In some embodiments, the terminal device 110 may receive, from the first network device 120, the lower-layer signaling indicating that the data transmission is to be enabled, and enable the data transmission based on the configuration. In some embodiments, the terminal device 110 may enable the data transmission by: informing, from a lower layer to a RRC layer of the terminal device 110, that the lower-layer signaling is received; and applying, by the RRC layer, the configuration corresponding to the data transmission to be enabled indicated by the lower-layer signaling. In some embodiments, the terminal device 110 may release the configuration from the variable after the enabling of the data transmission. In some embodiments, the terminal device 110 may maintain the configuration in the variable after the enabling of the data transmission.

In some embodiments where the data transmission is the first data transmission, the terminal device 110 may receive, from the first network device 120 or the second network device 130, a third message indicating that the cell 131 of the second network device 130 is to be released, and release the cell 131 of the second network device 130 based on the third message. In some embodiments, the third message may be comprised in a MAC CE or DCI. In some embodiments, the third message may comprise at least one of the following: an identity of the cell 131 of the second network device 130, information of a beam, or information indicating that a TCI state of the cell of the second network device 130 is to be deactivated.

In some embodiments, the terminal device 110 may release the cell 131 of the second network device 130 by: informing, from a lower layer to a RRC layer of the terminal device 110, that the third message is received; and releasing the configuration by the RRC layer.

In some embodiments where the third message is received from the second network device 130, the terminal device 110 may transmit, to the first network device 120, a fourth message indicating that the cell 131 of the second network device 130 is released.

In some embodiments, in response to detecting a failure for a MCG of the terminal device 110, the terminal device 110 may determine a selected cell by performing a cell selection. If the selected cell is the cell 131 of the second network device 130, the terminal device 110 may initiate a handover procedure by applying the configuration for the selected cell. In some embodiments, the initiating of the handover procedure is done in response to receiving, from the first network device 120, information indicating that the configuration is used for a recovery from the failure.

In some embodiments, in response to detecting a failure for a SCG of the terminal device 110, the terminal device 110 may determine a selected cell fulfilling a predetermined criterion. If the selected cell is the cell 131 of the second network device 130, the terminal device 110 may perform a PSCell change for the SCG by applying the configuration for the selected cell. In some embodiments, the performing the PSCell change for the SCG is done in response to receiving, from the first network device 120, information indicating that the configuration is used for a recovery from the failure.

In some embodiments, the terminal device 110 may start a timer upon the applying of the configuration. If the timer expiries, the terminal device 110 may determine that a failure in the data transmission occurs. In some embodiments, if the data transmission on the cell 131 of the second network device 130 is successfully enabled, the terminal device 110 may stop the timer. In some embodiments, a value of the timer may be indicated in the configuration.

In some embodiments where the data transmission is the first data transmission and the configuration comprises a set of parameters for beam failure detection or RLF detection on the cell 131 of the second network device 130, in response to detecting a beam failure or a RLF on the cell 131 of the second network device 130 based on the set of parameters, the terminal device 110 may determine that a failure in the data transmission occurs.

In some embodiments, upon determination of the failure in the data transmission, the terminal device 110 may transmit, to the first network device 120, information of the failure in the data transmission. In some embodiments, the information of the failure may comprise at least one of the following: an indication that the failure in the data transmission occurs, an index of the configuration, information of a cell associated with the failure, or information of a beam associated with the failure.

In some embodiments, the terminal device 110 may transmit, to the MN, the information of the failure in a RLF report or in a RRC message. In some embodiments, the RRC message may comprise a further RRC message to be transmitted to the SN, and the further RRC message comprise the information of the failure.

In some embodiments, the terminal device 110 may transmit, to the SN via a SRB3, a RRC message comprising the information of the failure.

In some embodiments, in response to receiving the lower-layer signaling from the MN, the terminal device 110 may transmit, to the MN, a MAC CE or DCI comprising the information of the failure. In some embodiments, in response to receiving the lower-layer signaling from the SN, the terminal device 110 may transmit, to the SN, a MAC CE or DCI comprising the information of the failure.

In this way, the terminal device may enable a L1/L2 based procedure based on a stored configuration for the L1/L2 based procedure. Further, the terminal device may recovery from a failure based on the stored configuration, and report a failure of the L1/L2 based procedure to the network side.

FIG. 4 illustrates an example method 400 of communication implemented at a network device in accordance with some embodiments of the present disclosure. For example, the method 400 may be performed at the first network device 120 as shown in FIG. 1A. For the purpose of discussion, in the following, the method 400 will be described with reference to FIG. 1A. It is to be understood that the method 400 may include additional blocks not shown and/or may omit some blocks as shown, and the scope of the present disclosure is not limited in this regard. The first network device 120 may be a MN or SN serving the terminal device 110. The first network device 120 provides a serving cell (for example, the cell 121) for the terminal device 110. The second network device 130 does not provide a serving cell for the terminal device 110.

As shown in FIG. 4, at block 410, the first network device 120 transmits, to the terminal device 110, a configuration to be applied to enable a data transmission on the cell 131 of the second network device 130 based on a lower-layer signaling.

In some embodiments, the configuration may be associated with at least one of the following: an index of the configuration, information of the cell 131 of the second network device 130, or information of a beam.

In some embodiments, the configuration may comprise at least one of the following: a radio resource configuration, or an access stratum security configuration. In some embodiments, the radio resource configuration may comprise at least one of the following: a radio bearer configuration, a MAC cell group configuration, or a physical channel configuration.

In some embodiments, the first network device 120 may transmit, to the terminal device 110, a first message indicating that the configuration is to be modified. In some embodiments, the first network device 120 may transmit, to the terminal device 110, a second message indicating that the configuration is to be released.

In some embodiments, the first network device 120 may transmit, to the terminal device 110, the lower-layer signaling indicating that the data transmission is to be enabled. In some embodiments where the data transmission is a first data transmission on the cell of the second network device without a change of a serving cell, the first network device 120 may transmit, to the terminal device 110, a third message indicating that the cell 131 of the second network device 130 is to be released. In some embodiments, the third message may be comprised in a MAC CE or DCI. In some embodiments, the third message may comprise at least one of the following: an identity of the cell 131 of the second network device 130, information of a beam, or information indicating that a TCI state of the cell 131 is to be deactivated.

In some embodiments where the data transmission is a first data transmission on the cell of the second network device without a change of a serving cell, the first network device 120 may receive, from the terminal device 110, a fourth message indicating that the cell 131 of the second network device 130 is released.

In some embodiments, the first network device 120 may transmit, to the terminal device 110, information indicating that the configuration is used for a recovery from a failure for a MCG of the terminal device 110. In some embodiments, the first network device 120 may transmit, to the terminal device 110, information indicating that the configuration is used for a recovery from a failure for a SCG of the terminal device 110.

In some embodiments, the configuration may indicate a value of a timer, the timer being used for detection of a failure in the data transmission.

In some embodiments, the first network device 120 may receive, from the terminal device 110, information of a failure in the data transmission. In some embodiments, the information of the failure may comprise at least one of the following: an indication that the failure in the data transmission occurs, an index of the configuration, information of a cell associated with the failure, or information of a beam associated with the failure.

In some embodiments where the first network device 120 is the MN, the first network device 120 may receive the information of the failure in a RLF report or in a RRC message from the terminal device 110. In some embodiments, the RRC message may comprise a further RRC message to be transmitted to the SN, and the further RRC message comprises the information of the failure.

In some embodiments where the first network device 120 is the SN, the first network device 120 may receive, from the terminal device 110 via a SRB3, a RRC message comprising the information of the failure.

In some embodiments, the first network device 120 may receive, from the terminal device 110, a MAC CE or DCI comprising the information of the failure.

In this way, the network side may configure and update a configuration for a L1/L2 based procedure. Further, the network side may obtain information of the failure of the L1/L2 based procedure and optimize the related network implementations.

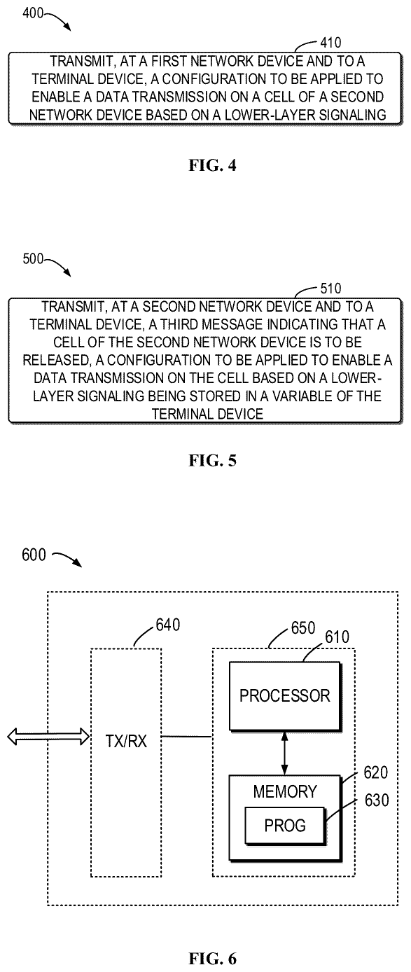

FIG. 5 illustrates another example method 500 of communication implemented at a network device in accordance with some embodiments of the present disclosure. For example, the method 500 may be performed at the second network device 130 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard. The first network device 120 may be a MN or SN serving the terminal device 110. The first network device 120 provides a serving cell (for example, the cell 121) for the terminal device 110. The second network device 130 does not provide a serving cell for the terminal device 110.

As shown in FIG. 5, at block 510, the second network device 130 transmits, to the terminal device 110, a third message indicating that the cell 131 of the second network device 130 is to be released. A configuration to be applied to enable a data transmission on the cell 131 based on a lower-layer signaling are stored in a variable of the terminal device 110 dedicated for the data transmission.

In some embodiments, the third message may be comprised in a MAC CE or DCI. In some embodiments, the third message may comprise at least one of the following: an identity of the cell 131 of the second network device 130, information of a beam, or information indicating that a TCI state of the cell 131 is to be deactivated.

In this way, the network side may optimize the related network implementations.

It is to be understood that the operations of methods 300 to 500 are similar as that described in connection with FIGS. 2A to 2D, and thus other details are not repeated here for concise.

### Example Implementation of Devices and Apparatuses

FIG. 6 is a simplified block diagram of a device 600 that is suitable for implementing embodiments of the present disclosure. The device 600 can be considered as a further example implementation of the terminal device 110 or the first network device 120 or the second network device 130 as shown in FIG. 1A. Accordingly, the device 600 can be implemented at or as at least a part of the terminal device 110 or the first network device 120 or the second network device 130.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 630 is assumed to include program instructions that, when executed by the associated processor 610, enable the device 600 to operate in accordance with the embodiments of the present disclosure, as discussed herein with reference to FIGS. 1A to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

In some embodiments, a terminal device comprises circuitry configured to: receive, from a first network device, a configuration to be applied to enable a data transmission on a cell of a second network device based on a lower-layer signaling, the first network device being a secondary node or a master node; and store the configuration in a variable of the terminal device dedicated for the data transmission.

In some embodiments, the configuration is associated with at least one of the following: an index of the configuration, information of the cell of the second network device, or information of a beam.

In some embodiments, the configuration comprises at least one of the following: a radio resource configuration, or an access stratum security configuration. In some embodiments, the radio resource configuration comprises at least one of the following: a radio bearer configuration, a medium access control cell group configuration, or a physical channel configuration.

In some embodiments, the circuitry may be configured to storing the configuration by: in accordance with a determination that the configuration is to be applied to enable a first data transmission on the cell of the second network device without a change of a serving cell, storing the configuration in a first variable of the terminal device; or in accordance with a determination that the configuration is to be applied to enable a second data transmission on the cell of the second network device with the change of the serving cell, storing the configuration in a second variable of the terminal device. In some embodiments, the first variable and the second variable are the same variable. In some embodiments, the first variable and the second variable are different variables.

In some embodiments, the circuitry may be configured to storing the configuration by: in response to receiving the configuration from the master node, storing the configuration in a third variable of the terminal device; or in response to receiving the configuration from the secondary node, storing the configuration in a fourth variable of the terminal device. In some embodiments, the third variable and the fourth variable are the same variable. In some embodiments, the third variable and the fourth variable are different variables.

In some embodiments, the circuitry may be further configured to: receive, from the first network device, a first message indicating that the configuration is to be modified; and modify the stored configuration based on the first message. In some embodiments, the circuitry may be further configured to: receive, from the first network device, a second message indicating that the configuration is to be released; and release the stored configuration based on the second message.

In some embodiments, the circuitry may be further configured to: receive, from the first network device, the lower-layer signaling indicating that the data transmission is to be enabled; and enable the data transmission based on the configuration. In some embodiments, the circuitry may be configured to enable the data transmission by informing, from a lower layer to a radio resource control layer of the terminal device, that the lower-layer signaling is received; and applying, by the radio resource control layer, the configuration corresponding to the data transmission to be enabled indicated by the lower-layer signaling.

In some embodiments, the circuitry may be further configured to: release the configuration from the variable after the enabling of the data transmission; or maintain the configuration in the variable after the enabling of the data transmission.

In some embodiments where the data transmission is a first data transmission on the cell of the second network device without a change of a serving cell, the circuitry may be further configured to: receive, from the first network device or the second network device, a third message indicating that the cell of the second network device is to be released; and release the cell of the second network device based on the third message. In some embodiments, the third message is comprised in a medium access control control element or downlink control information. In some embodiments, the third message comprises at least one of the following: an identity of the cell of the second network device, information of a beam, or information indicating that a transmission configuration index state of the cell of the second network device is to be deactivated.

In some embodiments, the circuitry may be configured to release the cell by: informing, from a lower layer to a radio resource control layer of the terminal device, that the third message is received; and releasing the configuration by the radio resource control layer.

In some embodiments where the third message is received from the second network device, the circuitry may be further configured to transmit, to the first network device, a fourth message indicating that the cell of the second network device is released.

In some embodiments, the circuitry may be further configured to: in response to detecting a failure for a master cell group of the terminal device, determining a selected cell by performing a cell selection; and in accordance with a determination that the selected cell is the cell of the second network device, initiating a handover procedure by applying the configuration for the selected cell. In some embodiments, the initiating of the handover procedure is done in response to receiving, from the first network device, information indicating that the configuration is used for a recovery from the failure.

In some embodiments, the circuitry may be further configured to: in response to detecting a failure for a secondary cell group of the terminal device, determining a selected cell fulfilling a predetermined criterion; and in accordance with a determination that the selected cell is the cell of the second network device, performing a change of a primary cell for the secondary cell group by applying the configuration for the selected cell. In some embodiments, the performing the change of the primary cell for the secondary cell group is done in response to receiving, from the first network device, information indicating that the configuration is used for a recovery from the failure.

In some embodiments, the circuitry may be further configured to: start a timer upon the applying of the configuration; and in accordance with a determination that the timer expiries, determine that a failure in the data transmission occurs. In some embodiments, the circuitry may be further configured to: in accordance with a determination that the data transmission on the cell of the second network device is successfully enabled, stop the timer. In some embodiments, a value of the timer is indicated in the configuration.

In some embodiments where the data transmission is a first data transmission on the cell of the second network device without a change of a serving cell, and the configuration comprises a set of parameters for beam failure detection or radio link failure detection on the cell of the second network device, the circuitry may be further configured to: in response to detecting a beam failure or a radio link failure on the cell of the second network device based on the set of parameters, determine that a failure in the data transmission occurs.

In some embodiments, the circuitry may be further configured to transmit, to the first network device, information of the failure in the data transmission. In some embodiments, the information of the failure comprises at least one of the following: an indication that the failure in the data transmission occurs, an index of the configuration, information of a cell associated with the failure, or information of a beam associated with the failure.

In some embodiments, the circuitry may be configured to transmit the information of the failure by transmitting, to the master node, the information of the failure in a radio link failure report or in a radio resource control message. In some embodiments, the radio resource control message comprises a further radio resource control message to be transmitted to the secondary node, and the further radio resource control message comprises the information of the failure.

In some embodiments, the circuitry may be configured to transmit the information of the failure by transmitting, to the secondary node and via a SRB3, a radio resource control message comprising the information of the failure.

In some embodiments, the circuitry may be configured to transmit the information of the failure by: in response to receiving the lower-layer signaling from the master node, transmitting, to the master node, a medium access control control element or downlink control information comprising the information of the failure; or in response to receiving the lower-layer signaling from the secondary node, transmitting, to the secondary node, a medium access control control element or downlink control information comprising the information of the failure.

In some embodiments, a network device comprise a circuitry configured to: transmit, at a first network device and to a terminal device, a configuration to be applied to enable a data transmission on a cell of a second network device based on a lower-layer signaling, the first network device being a secondary node or a master node.

In some embodiments, the configuration is associated with at least one of the following: an index of the configuration, information of the cell of the second network device, or information of a beam.

In some embodiments, the configuration comprises at least one of the following: a radio resource configuration, or an access stratum security configuration. In some embodiments, the radio resource configuration comprises at least one of the following: a radio bearer configuration, a medium access control cell group configuration, or a physical channel configuration.

In some embodiments, the circuitry may be further configured to transmit, to the terminal device, a first message indicating that the configuration is to be modified. In some embodiments, the circuitry may be further configured to transmit, to the terminal device, a second message indicating that the configuration is to be released.

In some embodiments, the circuitry may be further configured to transmit, to the terminal device, the lower-layer signaling indicating that the data transmission is to be enabled.

In some embodiments where the data transmission is a first data transmission on the cell of the second network device without a change of a serving cell, the circuitry may be further configured to: transmit, to the terminal device, a third message indicating that the cell of the second network device is to be released. In some embodiments, the third message is comprised in a medium access control control element or downlink control information. In some embodiments, the third message comprises at least one of the following: an identity of the cell of the second network device, information of a beam, or information indicating that a transmission configuration index state of the cell is to be deactivated.

In some embodiments where the data transmission is a first data transmission on the cell of the second network device without a change of a serving cell, the circuitry may be further configured to receive, from the terminal device, a fourth message indicating that the cell of the second network device is released.

In some embodiments, the circuitry may be further configured to at least one of the following: transmit, to the terminal device, information indicating that the configuration is used for a recovery from a failure for a master cell group of the terminal device; or transmit, to the terminal device, information indicating that the configuration is used for a recovery from a failure for a secondary cell group of the terminal device.

In some embodiments, the configuration indicates a value of a timer, the timer being used for detection of a failure in the data transmission.

In some embodiments, the circuitry may be further configured to receive, from the terminal device, information of a failure in the data transmission. In some embodiments, the information of the failure comprises at least one of the following: an indication that the failure in the data transmission occurs, an index of the configuration, information of a cell associated with the failure, or information of a beam associated with the failure.

In some embodiments where the first network device is the master node, the circuitry may be configured to receive the information of the failure by receiving the information of the failure in a radio link failure report or in a radio resource control message from the terminal device. In some embodiments, the radio resource control message comprises a further radio resource control message to be transmitted to the secondary node, and the further radio resource control message comprises the information of the failure.

In some embodiments where the first network device is the secondary node, the circuitry may be configured to receive the information of the failure by receiving, from the terminal device via a SRB3, a radio resource control message comprising the information of the failure.

In some embodiments, the circuitry may be configured to receive the information of the failure by receiving, from the terminal device, a medium access control control element or downlink control information comprising the information of the failure.

In some embodiments, a network device comprises a circuitry configured to transmit, at a second network device and to a terminal device, a third message indicating that a cell of the second network device is to be released, a configuration to be applied to enable a data transmission on the cell based on a lower-layer signaling being stored in a variable of the terminal device dedicated for the data transmission.

In some embodiments, the third message is comprised in a medium access control control element or downlink control information. In some embodiments, the third message comprises at least one of the following: an identity of the cell of the second network device, information of a beam, or information indicating that a transmission configuration index state of the cell is to be deactivated.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-58. (canceled)

59. A method of a User Equipment (UE) comprising:
receiving, from a base station, a Radio resource control (RRC) message-comprising configuration information related to a candidate cell for Layer1/Layer2 triggered mobility,
storing the configuration information in a variable,
in a case where the UE receives, from the base station, a Medium Access Control (MAC) Control Element (CE) comprising a configuration index, applying the stored configuration information indicated by the configuration index, wherein the stored configuration information is information of the RRC message, and
performing cell switch to a target cell.

60. The method of claim 59, further comprising:
a MAC entity, wherein
in a case where the MAC entity receives the MAC CE and indicates information related to the MAC CE to upper layer, the UE applies the stored configuration information.

61. The method of claim 59, further comprising:
storing second configuration information related to a second candidate cell,
in a case where the UE detects radio link failure (RLF) of the Master Cell Group (MCG), selecting a cell, and
in a case where the selected cell is the second candidate cell, performing second cell switch for the selected cell.

62. The method of claim 59, further comprising:
starting a timer T304, in a case where the UE applies the configuration information, and
stopping the timer T304, in a case where the UE receives a Physical Downlink Control Channel (PDCCH) transmission addressed to Cell Radio Network Temporary Identifier (C-RNTI).

63. The method of claim 59, further comprising:
activating Transmission Configuration Indicator (TCI) state of the candidate cell before the candidate cell become a serving cell.

64. A User Equipment (UE), comprising:
a memory storing instructions; and
a processor configured to execute the instructions to:
receive, from a base station, a Radio resource control (RRC) message-comprising configuration information related to a candidate cell for Layer1/Layer2 triggered mobility,
store the configuration information in a variable,
in a case where the UE receives, from the base station, a Medium Access Control (MAC) Control Element (CE) comprising a configuration index, apply the stored configuration information indicated by the configuration index, wherein the stored configuration information is information of the RRC message, and
perform cell switch to a target cell.

65. The UE of claim 64, further comprising:
a MAC entity, wherein the processor is configured to execute the instruction to:
in a case where the MAC entity receives the MAC CE and indicates information related to the MAC CE to upper layer, apply the stored configuration information.

66. The UE of claim 64, wherein the processor is further configured to execute the instruction to:
store second configuration information related to a second candidate cell,
in a case where the UE detects radio link failure (RLF) of the Master Cell Group (MCG), select a cell, and
in a case where the selected cell is the second candidate cell, perform second cell switch for the selected cell.

67. The UE of claim 64, wherein the processor is further configured to execute the instruction to:
start a timer T304, in a case where the UE applies the configuration information, and
stop the timer T304, in a case where the UE receives a Physical Downlink Control Channel (PDCCH) transmission addressed to Cell Radio Network Temporary Identifier (C-RNTI).

68. The UE of claim 64, wherein the processor is further configured to execute the instruction to:
activate Transmission Configuration Indicator (TCI) state of the candidate cell before the candidate cell become a serving cell.
